(19) United States
(12) Patent Application Publication
(10) Pub. No.: US 2007/0228784 A1
(43) Pub. Date: Oct. 4, 2007

(54) Vehicle safety seat

(76) Inventor: James D. Wells JR., TALLAHASSEE, FL (US)

Correspondence Address: WILLIAM H. HOLLIMON, 215 SOUTH MONROE STREET, 2ND FLOOR, TALLAHASSEE, FL, 32301, US

(21) Appl. No.: 11/596,966

(22) PCT Filed: Jun. 1, 2005
(86) PCT No.: PCT/US05/19193

§ 371 Date: Nov. 17, 2006

Related U.S. Application Data
(60) Provisional application No. 60/575,866, filed on Jun. 2, 2004.

(51) Int. Cl. B60N 2/427; B60R 21/02

(52) U.S. Cl. 297/216.14; 297/216.1; 297/216.15; 297/216.16

(57) ABSTRACT

A vehicle safety seat has connections between the seat, seat brackets, and the vehicle floor that allow the safety seat to move rearward, in a controlled fashion, in the event of a rear end collision, thereby reducing the peak level of impact forces normally applied to the seat occupant during a collision event.

### TECHNICAL FIELD

This invention generally relates to controlling the movement of a vehicle seat during a vehicle collision event. More particularly, the present invention pertains to a system and method for allowing controlled, rearward movement of a vehicle seat during a collision event, thereby reducing the peak level of impact forces normally applied to the seat occupant during a collision.

### BACKGROUND ART

A significant number of auto accidents involve rear end collisions. The passengers in the rear car are subjected to the sudden deceleration resulting from a front end collision, and are protected by seat belts, air bags, and compliant steering wheels. On the other hand, the impacted vehicle is accelerated forward, subjecting the passengers to impact forces to their backs, necks, and heads. Where the difference in velocities between the front and rear vehicles is low, the primary form of injury is whiplash to a passenger's neck. The neck or cervical column of the passenger is thereby subjected to abnormal stresses but there is still no complete knowledge on which movements in a complicated pattern of movements actually damage the neck. It is, however, known that such injuries can be significantly reduced if the passenger has effective support for both the body and the head during a collision.

In high speed accidents, where the difference in velocity of the two vehicles is great, a passenger's body can be subjected to substantial forces as the seat back is accelerated forward and the passenger's body is forced into the seat back. These substantial forces create a much greater risk for serious bodily injury. It is known that the peak magnitude of the force imposed upon a passenger's body in a rear end collision may be reduced by maintaining the proper head, neck, and torso alignment and by increasing the distance the passenger can travel during impact, thereby increasing the time in which the collision forces are absorbed and reducing the peak magnitude of these forces.

One current technology for reducing the magnitude of the force imposed upon the seat occupant's body employs a collapsing seat back that is designed to move rearward, thereby increasing the angle between the seat cushion and the seat back. While this technology is effective in reducing the total impact force absorbed by the seat occupant's body, it suffers from the disadvantage that the collapsing seat back can act as a ramp directing the seat occupant into the vehicle roof or rear seat area, thereby creating the potential for significant injury to the seat occupant. Further, if the rear seat is occupied, this technology has the additional disadvantage of increasing the chance of rear seat occupants being injured by collision with rearward-moving front seat occupants.

Another technology, while maintaining the relative position of the seat cushion to the seat back during a rear end collision, allows the front portion of the seat to rise, thereby allowing the seat back to recline. Again, this technology suffers from the disadvantage of creating a ramp directing the seat occupant into the roof or back seat.

Other attempts to address these problems include seatbacks with internal bladders designed to deflate upon input from a crash sensor and seatbacks utilizing electric motors to change the position of the seat back upon activation by crash sensors.

With regard to head restraints, various systems have been designed to pivot the head restraint forward in the event of a rear end collision. These systems variously include linkage systems, crash sensor actuated systems, and inertial systems.

These current passenger restraint systems fail to address the potential for injury sufficiently. These systems do not maintain the proper alignment of the torso, neck, and body during a rear end collision and allow a passenger to “ramp” into the vehicle roof or rear seat area. These systems are complex, expensive, and difficult to manufacture and do not provide an effective and efficient method to dissipate crash impact forces. Moreover, because these systems are integrated into the vehicle seat, they do not allow for easy retrofit of existing seating systems.

These current systems suffers from one or more of the following disadvantages:
1. The vehicle seat back is allowed to recline and create a ramp;
2. The vehicle seat back does not maintain the proper alignment of the torso, neck, and head in the event of a rear end collision;
3. The seating system does not effectively and efficiently dissipate crash impact forces;
4. The seat apparatus is complex, expensive, and difficult to manufacture;
5. The seat apparatus does not prevent frontward seat occupants from moving rearward and contacting rearward seat occupants; and
6. The seat apparatus cannot be easily retrofitted to existing seat systems.

For the foregoing reasons, there is a need for a vehicle safety seat that maintains the relative position of the vehicle seat to the seat back and maintains the proper alignment of the torso, neck, and head of a seat occupant in the event of a rear end collision, which does not create a ramp, which effectively and efficiently dissipates crash impact forces, and which is of simple design that is inexpensive to manufacture and easy to retrofit into existing seating systems.

### DISCLOSURE OF INVENTION

The present invention is directed to a vehicle safety seat that satisfies this need.

Accordingly, several objects and advantages of the present invention are:

1. to maintain the relative position of the vehicle seat to the seat back and maintain the proper alignment of the torso, neck, and head of a seat occupant in the event of a rear end collision;
2. to not create a ramp for directing a forward seat occupant into the vehicle roof or into a rearward seating area; and
3. to be of simple design that is inexpensive to manufacture and easy to retrofit into existing seating systems;

According to the present invention, the vehicle safety seat includes a seat cushion with at least one seat track attached to the bottom of the seat cushion, a seat back arranged on a rear portion of the seat cushion, at least one front bracket adapted to be operatively connected to the seat track and operatively connected to the vehicle floor, and at least one rear bracket adapted to be operatively connected to the seat track and operatively connected to the vehicle floor. A head rest extends from the seat back and is adjustable to allow positioning of the head rest in close proximity to the seat occupant's head. In the event of a rear end collision, the connections between the seat bottom, the seat track, and the front and rear brackets are adapted such that the seat cushion, seat back, and head rest assembly are allowed to move rearward in a controlled fashion while maintaining the spatial relationship between the seat cushion and the seat back, the seat cushion and the vehicle floor, and the seat occupant's head and the head rest.

### BRIEF DESCRIPTION OF DRAWINGS

These and other features, aspects, and advantages of the present invention will become better understood with regard to the following description, appended claims, and accompanying drawings wherein:

FIG. 1A is a side elevation showing a seat occupant sitting in a vehicle seat designed to collapse upon rear end impact;

FIG. 1B is a side elevation showing a seat occupant ramping up a seat back designed to collapse in the event of a rear end collision;

FIG. 2A is a side elevation showing a seat occupant sitting in a vehicle seat designed to remain rigid upon rear end impact;

FIG. 2B is a side elevation showing a seat occupant, post impact, in a vehicle seat designed to remain rigid upon rear end impact;

FIG. 3A is a side elevation showing a seat occupant sitting in a vehicle seat of the present invention prior to a rear end collision;

FIG. 3B is a side elevation showing a seat occupant sitting in a vehicle seat of the present invention after a rear end collision;

FIG. 4A is a side elevation of the seat bottom portion of one embodiment of the present invention prior to a rear end collision;

FIG. 4B is a side elevation of the seat bottom portion of one embodiment of the present invention after a rear end collision;

FIG. 5 is a top view of the front bracket shown in FIG. 4A and FIG. 4B;

FIG. 6 is a top view of the rear bracket shown in FIG. 4A and FIG. 4B;

FIG. 7A is a side elevation of the seat bottom portion of one embodiment of the present invention prior to a rear end collision;

FIG. 7B is a side elevation of the seat bottom portion of one embodiment of the present invention after a rear end collision;

FIG. 8 is a cross section of an embodiment of the seat track of the present invention.

FIG. 9 is a top view of the seat track shown in FIG. 8.

FIG. 10A is a side elevation of the seat track of one embodiment of the present invention prior to a rear end collision; and

FIG. 10B is a side elevation of the seat track of one embodiment of the present invention after a rear end collision.

The below table summarizes the reference numbers and associated element shown in the above drawings:
61 vehicle safety seat
62 head restraint
63 seat back
64 seat cushion
65 seat track
651 inner rail
652 outer rail
653 outer rail oblong hole
66 vehicle floor
67 front bracket
671 front bracket first attaching portion
672 front bracket second attaching portion
68 rear bracket
681 rear bracket first attaching portion
682 rear bracket second attaching portion
71 seat occupant
82 fasteners
90 front bracket oblong hole
91 rear bracket oblong hole
130 linear gear rack
131 position adjustment lever
132 spring
133 stop

### BEST MODE FOR CARRYING OUT THE INVENTION

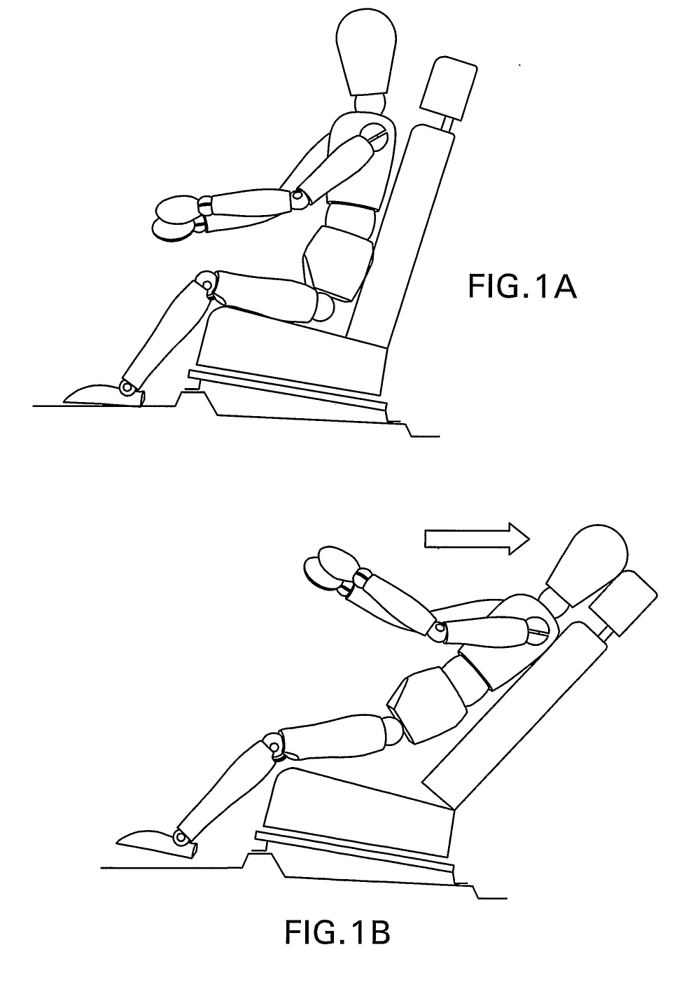

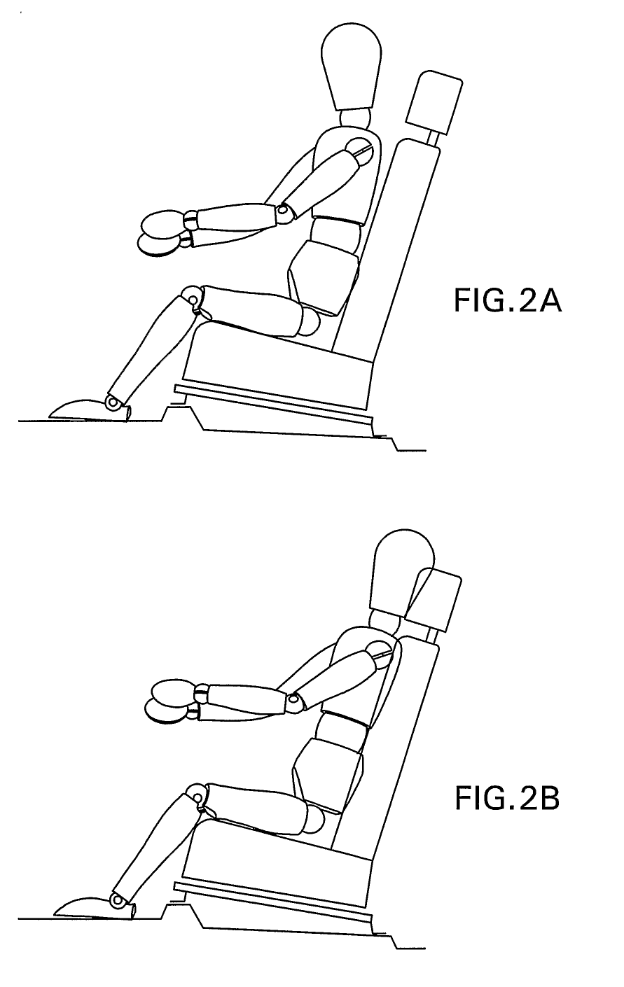

Referring to FIGS. 1A and 1B, a prior art vehicle seat that is designed for the seat back to collapse upon a rear-end collision is shown. As shown in FIG. 1B, the collapsing seat back creates a ramp effect, which allows a seat occupant to slide upward and rearward potentially impacting the vehicle's roof or the vehicle's back seat passengers. FIGS. 2A and 2B show a prior art vehicle seat that is designed to for the seat back to remain rigid in the event of a rear-end collision. As shown in FIG. 2B, the impact forces are immediately transferred from the seatback to the seat occupant.

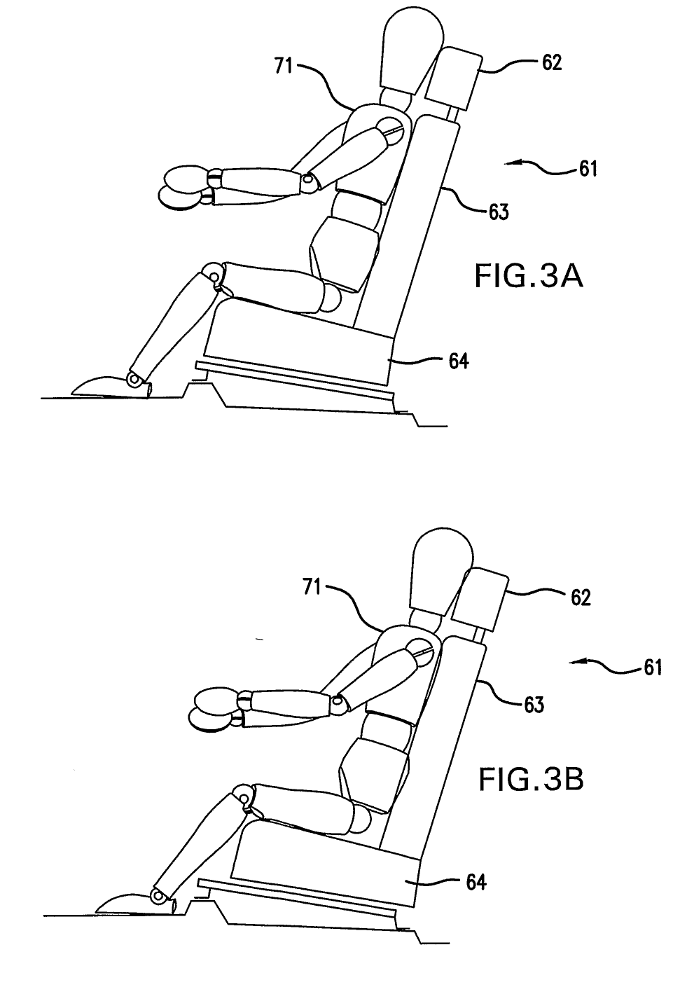

Referring to FIGS. 3A and 3B, an embodiment of the vehicle safety seat 61 of the present invention is shown. As shown in FIG. 3B, upon a rear-end collision event, seat cushion 64 has moved rearward, seat back 63 has remained in the upright position, and, thereby, the total impact force on seat occupant 71 has been lessened by applying these impact forces over a greater distance and over a greater time. As shown in FIG. 3B, during a rear end collision event, as seat back 63 is accelerated forward, seat occupant 71 is pushed into the seat back 63 and the head restraint 62. The collision impact forces upon the seat occupant 71 are damped by compression of the seat back 63 and the head rest 62. The peak magnitude of the collision impact forces upon seat occupant 71 is further mitigated because vehicle safety seat 61 includes means for allowing vehicle safety seat 61 to move rearward, with respect to vehicle floor 66, when the reactionary force imposed upon seat back 63 by seat occupant 71 exceeds a predetermined level. The exact force needed to move the seat must be determined by the vehicle designer because the peak acceleration force imposed upon a seat occupant during a rear end collision is partially a function of vehicle design. This rearward movement of vehicle safety seat 61 increases the time and distance over which to absorb the collision forces and thereby lowers the peak force upon the seat occupant 71.

A number of means for allowing this rearward movement of vehicle safety seat 61 are envisioned. One such means is to utilize frictionally forces to mechanically brake one or more connections between the seat cushion 64 and the seat rail 65; the seat rail 65 and the front bracket 67 and the rear bracket 67; the vehicle floor 66 and the front bracket 67 and the rear bracket 68.

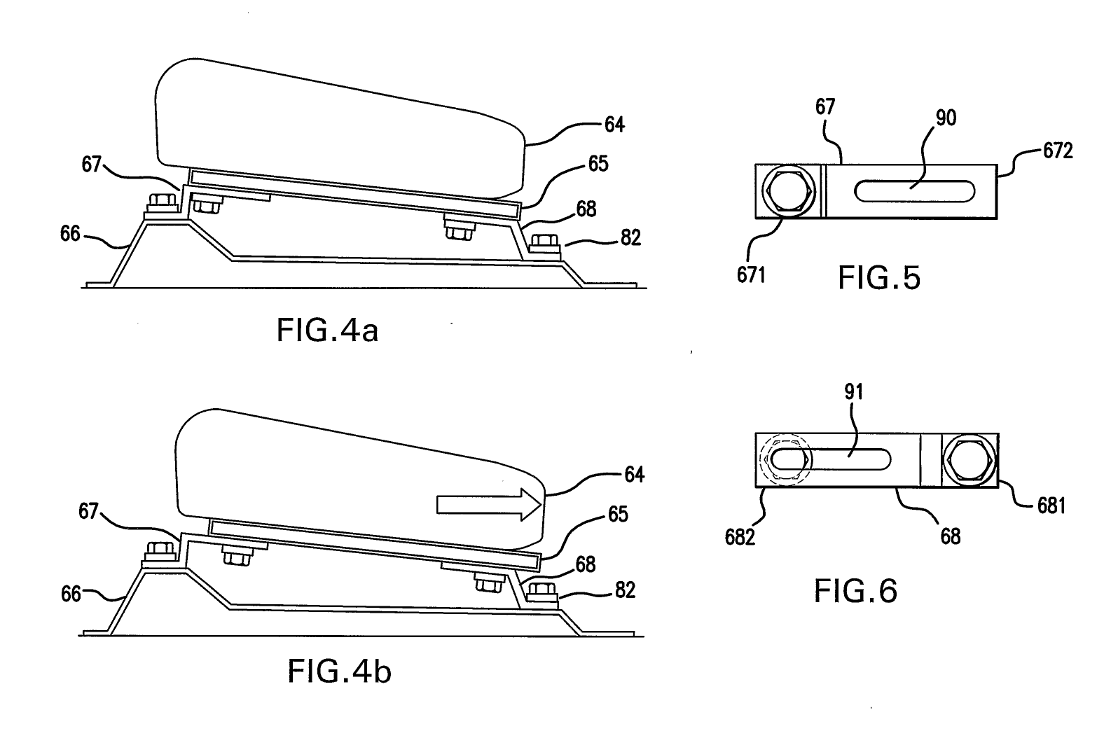

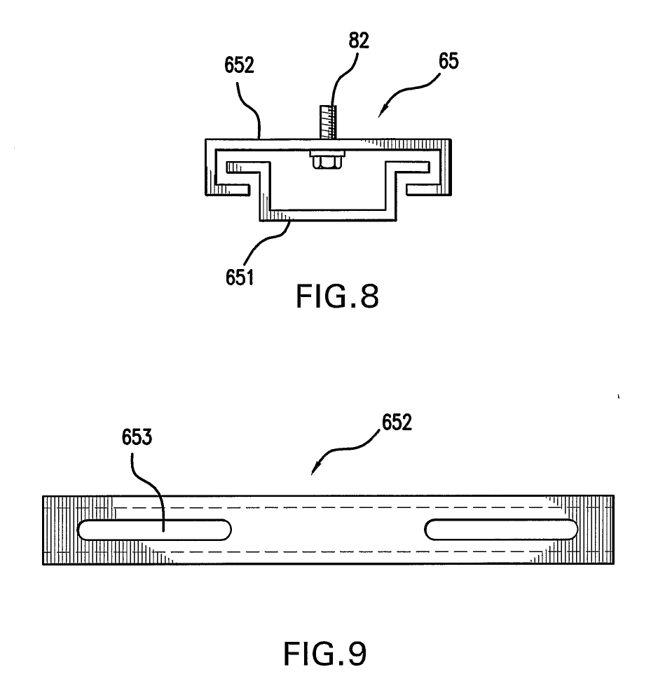

Referring to FIG. 4A, a side view of an embodiment of the vehicle safety seat 61 of the present invention is shown. For clarity, seat back 63 is not shown in this, or subsequent views. FIG. 4A shows seat cushion 64, at least one seat track 65, at least one front bracket 67, and at least one rear bracket 68. Seat track 65 is of conventional design and, as shown in FIG. 8, may be comprised of an inner rail 651 adapted to be connected to seat cushion 64 and an outer rail adapted to be connected to front bracket 67 and rear bracket 68. As shown in FIG. 8, inner rail 651 nests within outer rail 652. As is known in the art, this arrangement selectively allows inner rail 651 to slide with respect to outer rail 652 to effect forward and rearward position adjustment of a conventional vehicle seat. Once such a position adjustment is complete, inner rail 651 and outer rail 652 are locked together preventing relative motion between these rails. Alternatively, seat track 65 may be constructed from a square or rectangular cross section structural material such as aluminum or steel. As shown in FIG. 4A, seat track 65 is connected to front bracket 67 and rear bracket 68. Front bracket 67 and rear bracket 68 are connected to vehicle floor 66. Fastener 82 (typical) connects front bracket 67 and rear bracket 68 to vehicle floor 66 and seat rail 65.

Referring to FIG. 5, a top view of front bracket 67 is shown. Front bracket 67 includes first attaching portion 671 for mounting to vehicle floor 66, and second attaching portion 672, for connection to seat track 65. Front bracket 67 includes oblong hole 90, through which a fastener 82 is inserted for connection of front bracket 67 to seat track 65. Referring to FIG. 6, a top view of rear bracket 68 is shown. Rear bracket 68 includes first attaching portion 681 for mounting to vehicle floor 66, and second attaching portion 682, for connection to seat track 65. Rear bracket 68 includes oblong hole 91, through which a fastener 82 is inserted for connection of front bracket 67 to seat track 65. Fastener 82 is designed to frictionally mate seat track 65 and front bracket 67 and rear bracket 68. Alternatively, rear bracket 68 may include a deformable portion (not shown) in lieu of, or in addition to, allowing sliding in oblong hole 91. In this configuration, the portion of rear bracket 68 that is intermediate to first attaching portion 681 and second attaching portion 682 is selectively deformable upon application of a sufficient force. Further, rear bracket 68 may include an integral flange that is coplanar with first attaching portion 681 and parallel to second attaching portion 682 and extends along vehicle floor 66 in the direction of front bracket 67. Upon deformation of the intermediate portion of rear bracket 68, this flange rotates upward, maintaining the overall elevation of rear bracket 68 and limiting the amount of deformation of rear bracket 68 that may occur. Alternatively, front bracket 67 and rear bracket 68 may be integrally formed with seat track 65.

Referring to FIG. 4B, vehicle safety seat 61 is shown in its post-collision position. In this position, rearward acceleration forces have overcome the frictional forces between fasteners 82 and front bracket 67 and rear bracket 68, allowing fasteners 82 to slide in oblong holes 90 and 91. The amount of sliding is controlled by the length of oblong holes 90 and 91, and may be adjusted to accommodate different vehicle designs and expected impact acceleration forces. Front bracket 67 and rear bracket 68 may be constructed as one-piece, integral units. The fasteners 82 may be case hardened fasteners and also include washers suitable for bearing the preload applied and having a suitable coefficient of friction.

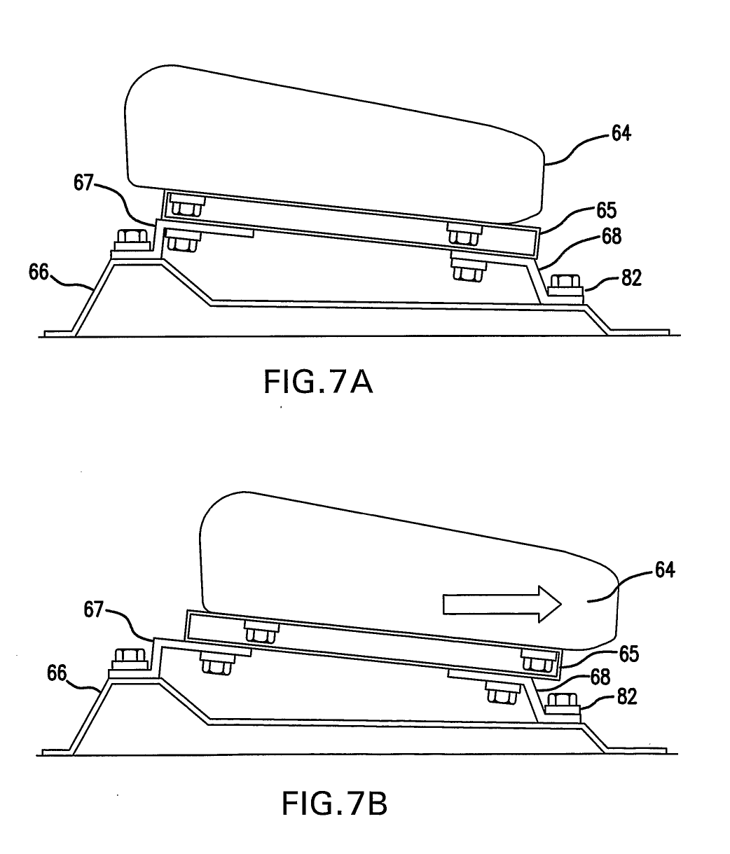

Referring to FIG. 7A, another embodiment of the present invention is shown. In this embodiment, sliding is allowed to occur between seat cushion 64 and seat track 65 as well as, or in lieu of, sliding between seat track 65 and front bracket 67 and rear bracket 68. As shown in FIG. 8, seat track 65 includes outer rail 652. Fastener 82 connects seat track 65 to seat cushion 64 (not shown). As shown in FIG. 9, outer rail 652 includes a pair of outer rail oblong holes 653, that allow fastener 82 to slide upon application of a sufficient force. Referring to FIG. 7B, vehicle safety seat 61 is shown in its post-collision position. As shown in FIG. 7B, sliding has occurred between seat track 65 and seat cushion 64 as well as between seat track 65 and front bracket 67 and rear bracket 68. One advantage of this embodiment is that fasteners 82 may be designed and preloaded to allow sliding to occur at different loading conditions. For example, a force of 20 G's may initiate sliding between seat cushion 64 and seat track 65, while a force of 30 G's may be required to initiate sliding between seat track 65 and front bracket 67 and rear bracket 68. This embodiment allows for an increase in the total slide distance allowed, and also offers additional flexibility in managing impact forces by allowing for two-staged sliding movement.

In all connections where sliding is to occur, the fasteners 82 are inserted through oblong holes, or slots, and positioned such that sliding in the forward direction is prevented. The length of the oblong hole determines the amount of sliding that may occur.

Upon occurrence of a rear end collision force of sufficient magnitude, the frictional force mating seat track 65 to seat cushion 64 and to front bracket 67 and rear bracket 68 is overcome and mechanically braked sliding occurs. Fasteners are preloaded such that sliding occurs only when a predetermined acceleration force is applied to the vehicle safety seat by the seat occupant. For example, if the predetermined acceleration force is 20 g's, then sliding will occur at forces above this magnitude, limiting the peak forces imposed upon a seat occupant. The magnitude of the preload applied to the fasteners is dependent upon the coefficients of friction of the mating materials where sliding occurs.

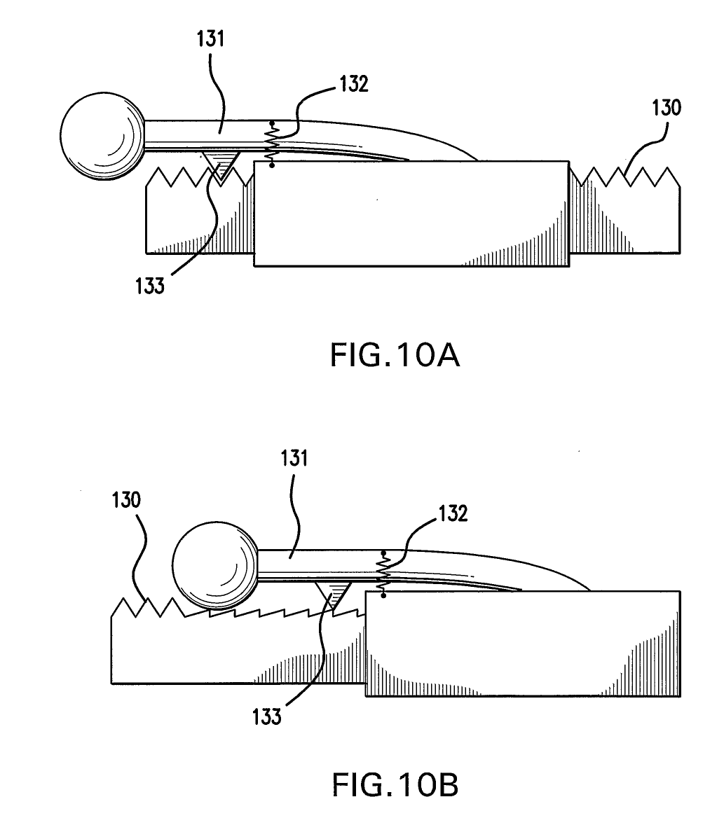

As shown in FIG. 10A, another embodiment of the present invention includes a linear gear rack 130 fixed to inner rail 651. Position adjustment lever 131 includes a stop 133 for engaging the linear gear rack 130 and is attached by a rotatable connection to outer rail 652. Spring 132 is attached between position adjustment lever 131 and outer rail 652 and provides tension to retain stop 133 in engagement with linear gear rack 130. Seat position adjustment is effected by overcoming the tension of spring 132, thereby disengaging stop 133 from linear gear rack 130, and allowing inner rail 651 to slide relative to outer rail 652. Stop 133 is formed from harder material than the corresponding teeth of linear gear rack 130.

In operation, as shown in FIG. 10B, during a rear end collision event where the reactionary force imposed upon seat back 63 by seat occupant 71 exceeds a predetermined level, spring 132 maintains stop 133 in operative engagement with linear gear rack 130 and, because stop 133 is constructed of harder material than the teeth of linear gear rack 130, individual teeth deform to allow relative motion between outer rail 652 and inner rail 651, thereby allowing rearward movement of vehicle safety seat 61 with respect to vehicle floor 66.

Many changes and modifications in the above described embodiments of the invention can, of course, be carried out without departing from the scope thereof. Accordingly, that scope is intended to be limited only by the scope of the appended claims.

### INDUSTRIAL APPLICABILITY

The present invention has applicability to seats in many modes of transportation, regardless of whether these seats are located in the front or rear of the transportation device. The present invention is applicable to any form of transportation where a rear-end collision event is possible, including, but not limited to, automobiles, buses, trucks, trains, and boats.

I claim:

1. A vehicle safety seat comprising:
a. a vehicle seat that includes a seat cushion and a seat back disposed on a rear portion of said seat cushion;
b. means for attaching said vehicle safety seat to a vehicle floor;
c. means for allowing said vehicle safety seat to controllably move rearward with respect to said vehicle floor.

2. The vehicle safety seat of claim 1 wherein said attaching means includes at least one attachment system, each attachment system including a seat track, said seat track adapted to be connected to said seat cushion, a front bracket adapted to be connected to said seat track and to said vehicle floor, a rear bracket adapted to be connected to said seat track and to said vehicle floor, and fastening means for securing said front bracket and said rear bracket to said seat track and for securing said seat track to said seat cushion.

3. The vehicle safety seat of claim 2 wherein said front bracket and said rear bracket are integral to said outer rail.

4. The vehicle safety seat of claim 1 wherein said means for allowing controlled, rearward movement is a slideable connection between said seat track and said seat cushion.

5. The vehicle safety seat of claim 1 wherein said means for allowing controlled, rearward movement is a slideable connection between said seat track and said front bracket and said rear bracket.

6. The vehicle safety seat of claim 1 wherein said means for allowing controlled, rearward movement is a slideable connection between said vehicle floor and said front bracket and between said vehicle floor and said rear bracket.

7. The vehicle safety seat of claim 1 wherein said means for allowing controlled, rearward movement is a slideable connection between said front bracket and said rear bracket and said seat rail, and a slideable connection between said seat rail and said seat cushion.

8. A vehicle safety seat comprising:
a. a vehicle seat that includes a seat cushion, a seat back arranged on a rear portion of said seat cushion, and at least one seat track;
b. at least one front bracket, said front bracket including a first attaching portion adapted to be connected to a vehicle floor and a second attaching portion adapted to be connected to said seat track, said second attaching portion further including an elongated hole therethrough;
c. at least one rear bracket, said rear bracket including a first attaching portion adapted to be connected to a vehicle floor and a second attaching portion adapted to be connected to said seat track, said second attaching portion further including an elongated hole therethrough;
d. means for connecting said at least one front bracket and said at least one rear bracket to said vehicle floor;
e. means for connecting said at least one front bracket and said at least one rear bracket to said seat track;
f. means for connecting said at least one seat track to said seat cushion;
g. means for allowing, upon occurrence of at least a first predetermined event related to a vehicle collision, limited, controlled, rearward movement of said vehicle seat substantially parallel to said floor of said vehicle.

9. The vehicle safety seat of claim 8 wherein, said means for allowing rearward movement includes a slideable connection between said at least one front bracket first attaching portion and said vehicle floor and a deformable connection between said seat track and said rear bracket.

10. The vehicle safety seat of claim 8 wherein, said means for allowing rearward movement includes a slideable connection between said at least one seat track and said seat cushion.

11. The vehicle safety seat of claim 8 wherein said means for allowing rearward movement is a slideable connection between said at least one seat track and said at least one front bracket and said at least one rear bracket.

12. The vehicle safety seat of claim 8 wherein said means for allowing rearward movement is a slideable connection between said vehicle floor and said at least one front bracket and between said vehicle floor and said at least one rear bracket.

13. The vehicle safety seat of claim 8 wherein said means for allowing rearward movement is a slideable connection between said at least one front bracket and said at least one rear bracket and said at least one seat rail, and a slideable connection between said at least one seat rail and said seat cushion.

14. The vehicle safety seat of claim 8 wherein said at least one front bracket and said at least one rear bracket are integral to said seat track.

15. The vehicle safety seat of claim 8 wherein said means for allowing rearward movement is a deformable linear gear rack attached to said seat track, a position adjustment lever capable of selectively engaging said deformable linear gear rack, said position adjustment lever further including a stop for engaging said linear gear rack and a tension system for maintaining operative engagement between said stop and said deformable linear gear rack

16. A vehicle safety seat comprising:
a. a vehicle seat that includes a seat cushion and a seat back arranged on a rear portion of said seat cushion;
b. means for attaching said seat cushion to a vehicle floor; and
c. sliding means for allowing, upon occurrence of at least a first predetermined event related to a vehicle collision, substantially parallel motion between said vehicle safety seat and said vehicle floor whereby said vehicle safety seat is allowed to move rearward with respect to said vehicle floor.

17. The vehicle safety seat of claim 16 wherein said sliding means is a deformable linear gear rack attached to said seat track, a position adjustment lever capable of selectively engaging said deformable linear gear rack, said position adjustment lever further including a stop for engaging said linear gear rack and a tension system for maintaining operative engagement between said stop and said deformable linear gear rack.

18. The vehicle safety seat of claim 16 wherein said attaching means includes at least one front bracket adapted to connect to said seat cushion and said vehicle floor and at least one rear bracket adapted to connect to said seat cushion and said vehicle floor.

19. The vehicle safety seat of claim 16 wherein said sliding means includes a slidable connection between said at least one front bracket and said seat cushion and between said at least one rear bracket and said seat cushion.
